(19) United States
(12) Patent Application Publication
(10) Pub. No.: US 2005/0018652 A1
(43) Pub. Date: Jan. 27, 2005

(54) System and method for proxy gatekeeper in H.323 based IP telephony systems

(75) Inventors: Richard Crouch, Gustine, CA (US); Randy Wuerfel, Santa Clara, CA (US)

Correspondence Address: Siemens Corporation;Attn: Elsa Keller, Legal Administrator, Intellectual Property Department, 170 Wood Avenue South, Iselin, NJ, 08830, US

(73) Assignee: Siemens Information and Communication Networks, Inc.

(21) Appl. No.: 10/624,404

(22) Filed: Jul. 21, 2003

(51) Int. Cl. H04L 12/66

(52) U.S. Cl. 370/352; 370/400

(57) ABSTRACT

A telecommunications system according to an embodiment of the present invention includes a packet network; a first plurality of network clients compatible with a first voice protocol of the network; a second plurality of network clients partially compatible with the first voice protocol; a third plurality of network clients compatible with a second voice protocol; a gatekeeper adapted to provide call control for the first plurality of network clients; a feature proxy adapted to receive registrations of the first plurality, the second plurality, and the third plurality of endpoints, and map such registrations to registrations with the gatekeeper and provide feature processing for the first, second, and third plurality of endpoints.

### BACKGROUND OF THE INVENTION

The present invention relates to telecommunications systems and, in particular, to an improved Internet Protocol telephone system.

Traditional private branch exchange (PBX) based telephone systems are increasingly being replaced or supplemented with Internet Protocol (IP) telephony systems and devices. However, different IP telephony systems employ different protocols. Exemplary IP telephone protocols include the ITU's Recommendation H.323 suite of protocols, the Session Initiation Protocol (SIP), MEGACO/H.248, MGCP and the like. Endpoints that are compatible with one protocol are typically not compatible with those of another. Furthermore, endpoints that relate to subsequent releases of a protocol may not be compatible with those from earlier releases. Thus, providing feature interworking between incompatible endpoints is an important aspect of the development of such systems.

For example, in the case of H.323 systems, intervening gateways can be used to interwork non-H.323 endpoints with an H.323 network. Such gateways support the registration of such endpoints in their native protocol and then register the devices with an H.323 gatekeeper. Intervening gateways also provide feature interworking between the non-H.323 endpoints and H.323 endpoints supporting H.450 features. While H.450 defines a gatekeeper-proxy model in which a proxy associated with the gatekeeper handles H.450 features on behalf of endpoints that do not themselves support H.450 features. However, the H.450 gatekeeper-proxy model only addresses feature invocation by endpoints that support H.450 and can thus invoke the H.450 features.

### SUMMARY OF THE INVENTION

These and other drawbacks in the prior art are overcome in large part by a system and method according to embodiments of the present invention.

A telecommunications system according to an embodiment of the present invention includes a packet network; a first plurality of network clients compatible with a first voice protocol of the network; a second plurality of network clients partially compatible with the first voice protocol; a third plurality of network clients compatible with a second voice protocol; a gatekeeper adapted to provide call control for the first plurality of network clients; a feature proxy adapted to receive registrations of the first plurality, the second plurality, and the third plurality of endpoints, and map such registrations to registrations with the gatekeeper and provide feature processing for the first, second, and third plurality of endpoints.

A better understanding of these and other specific embodiments of the invention is obtained when the following detailed description is considered in conjunction with the following drawings.

### BRIEF DESCRIPTION OF THE DRAWINGS

FIG. 1 is a diagram of a telecommunications system according to an embodiment of the present invention;

FIG. 2 is a block diagram illustrating a feature proxy according to an embodiment of the present invention;

FIG. 3 is a diagram illustrating operation of an embodiment of the present invention;

FIG. 4 is a diagram illustrating operation of an embodiment of the present invention;

FIG. 5 is a diagram illustrating operation of an embodiment of the present invention;

FIG. 6 is a diagram illustrating operation of an embodiment of the present invention;

FIG. 7 is a diagram illustrating operation of an embodiment of the present invention;

FIG. 8 is a diagram illustrating operation of an embodiment of the present invention;

FIG. 9 is a diagram of an embodiment of the present invention; and

FIG. 10 is a diagram illustrating operation of an embodiment of the present invention.

### DETAILED DESCRIPTION OF EMBODIMENTS OF THE INVENTION

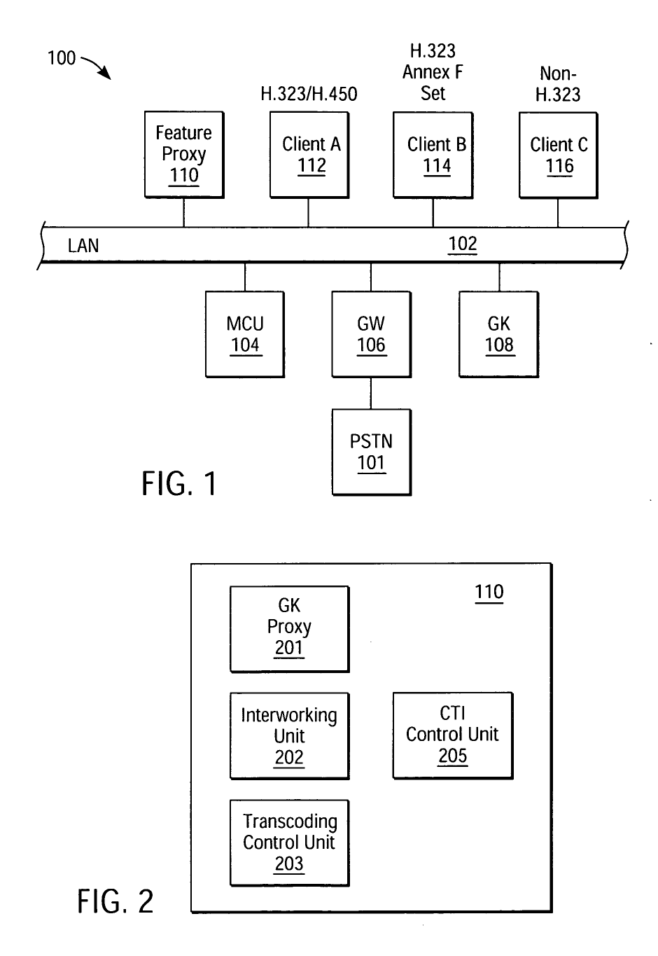

Turning now to the drawings and, with particular attention to FIG. 1, a multimedia telecommunications system according to an embodiment of the present invention is shown and generally identified by the reference numeral 100. As will be explained in greater detail below, the telecommunications system 100 includes a feature proxy 110 used for interworking between H.323 endpoints and H.323 endpoints that do not support H.450 supplementary services, and that may also include an embedded gatekeeper proxy.

In the embodiment illustrated, the telecommunications system 100 includes a packet network 102 such as a local area network, a multipoint control unit (MCU) 104, a gateway 106, a gatekeeper 108, the feature proxy 110, and a variety of network clients 112, 114, 116. It is noted, however, that other network configurations are possible.

As shown, the H.323 gateway 106 interfaces to a switched circuit network 101 and generally provides a translation function between H.323 conferencing endpoints in their zones and other terminal types, and performs call setup and clearing on both the LAN side and switched circuit network side. The MCU 104 allows for multipoint conferencing capabilities. As is known, the H.323 gatekeeper 108 performs address translation from LAN aliases for terminals and gateways to IP or IPX addresses (as defined in the H.225.0 specification) as well as bandwidth management (also specified within the H.225.0 specification). The H.323 gatekeeper 108 is further used for call routing.

The client endpoints 112, 114 are in compliance with the H.323 standard. Thus, the H.323 terminals 112, 114 support H.245 for negotiation of channel usage, H.225.0 and H.323 for call signaling and call setup, registration admission status (RAS), and RTP/RTCP for sequencing audio and video packets. The H.323 terminals 112, 114 may further implement audio and video codecs, T.120 data conferencing protocols and MCU capabilities. Further details concerning the Recommendations H.323, H.225.0 and H.245 may be obtained from the International Telecommunications Union (ITU); the Recommendations are hereby incorporated by reference in their entirety as if fully set forth herein.

In addition, the endpoint 112 may also implement supplementary services according to the H.450 series of protocol specifications. As will be explained in greater detail below, however, the endpoint 114 may be implemented as an H.323, Annex F Simple Endpoint Type (SET) device and does not support H.450 supplementary services and relies, instead, on the feature proxy 110 to provide such services. That is, the feature proxy 110 accepts registrations from endpoints such as endpoint 114 and passes the registration messages through to the gatekeeper 108.

The endpoint 116 is not an H.323 endpoint. For example, the endpoint 116 may be embodied as a SIP endpoint, an MGCP endpoint, or a MEGACO/H.248 endpoint. As will be explained in greater detail below, such endpoints register with the feature proxy and the feature proxy registers the devices with the gatekeeper 108.

Turning now to FIG. 2, a block diagram of an exemplary feature proxy 110 according to an embodiment of the present invention is shown. The feature proxy 110 may be implemented as one or more software modules running on a controller such as a microprocessor. As shown, the feature proxy 110 may include one or more of a gatekeeper proxy 201, an interworking unit 202, a transcoding unit 203, and a CTI control unit 205.

As will be explained in greater detail below, the interworking unit 202 may be embodied as an H.323 to non-H.323 interworking unit, to allow H.323 endpoints and non-H.323 endpoints to communicate. In operation, the interworking unit 202 may be adapted to receive registration and other requests from non-H.323 endpoints, as well as H.323 gatekeepers, and process them, such that to the gatekeeper 108, the feature proxy 110 appears as an H.323 client.

In other embodiments, the interworking unit 202 may be embodied as an H.323 to an H.323/non-H.450 interworking unit. In such an embodiment, the gatekeeper proxy 201 receives standard H.323 commands and forwards them to the gatekeeper 108, while the interworking unit 202 handles H.450 commands and functions. The interworking unit 202 thus may include one or more databases mapping functionalities of one protocol to another.

The feature proxy 110 may further include a transcoding control unit 203. The transcoding control unit 203 provides for, e.g., codec conversions when the voice path is not compatible, i.e., provides for conversion between coding schemes.

Finally, the feature proxy may include a CTI (Computer-Telephony-Interface) control unit 205. The CTI control unit 205 allows the feature proxy 110 to send a CTI application, for example, running on a server (not shown) a stream of control information concerning attached telephones. The application can then be used, e.g., to make calls via the telephone.

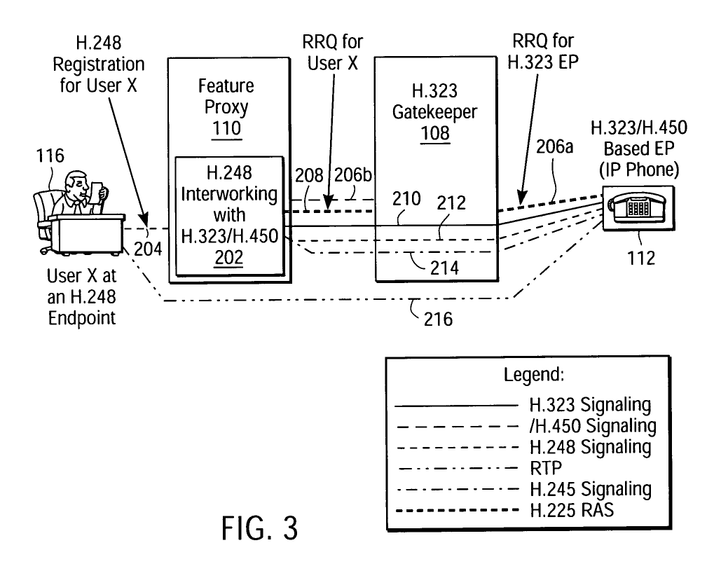

Turning now to FIG. 3, a diagram illustrating operation of an embodiment of the present invention is shown. In particular, shown is an example of a user registering from an endpoint 116 that is not an H.323 endpoint. For example, the endpoint 116 might be an H.248 endpoint, although handling for other non-H.323 endpoints is similar. Shown in FIG. 3 are an H.323/H.450 compliant endpoint 112, an H.323 gatekeeper 108, the feature proxy 110, and a non-H.323 endpoint 116. As will be explained in greater detail below, the feature proxy 110 includes an interworking control unit 202 and, in particular, an H.248 interworking with H.323/H.450 interworking unit.

At 204, the non-H.323 endpoint 116 registers with the feature proxy using its native protocol (i.e., H.248 in this example). At 206a, the H.323 endpoint 112 sends an H.225.0 RRQ (Registration Request) message to the H.323 gatekeeper 108. The RRQ request is sent to the feature proxy 110 at 206b. This may be accomplished either by configuring the endpoint with the feature proxy's address or by the gatekeeper 108 redirecting the RRQ to the feature proxy 110, using the H.323 alternate gatekeeper provision. The feature proxy 110 receives the RRQ and sends its own RRQ request on behalf of the H.323 endpoint 112 to the gatekeeper 108. This indicates the feature proxy 110 as the address of the user. Thus, all signaling and call information for the user is routed to the feature proxy 110. Similarly, at 208, the feature proxy 110 sends an RRQ to the gatekeeper 108 for the H.248 endpoint 116. The feature proxy 110 can then process and relay H.225.0 RAS and H.225.0 signaling messages, H.245 control messages, H.450 messages, and cryptographic tokens for support of H.235 security procedures between the endpoints and the H.323 gatekeeper. RTP signaling is handled directly between the endpoints. As shown, H.225.0 signaling 210, H.450 signaling 212, and H.245 signaling 214 are provided to the feature proxy 110 via the gatekeeper 108. One or more RTP media channels 216 can then be opened between the endpoints.

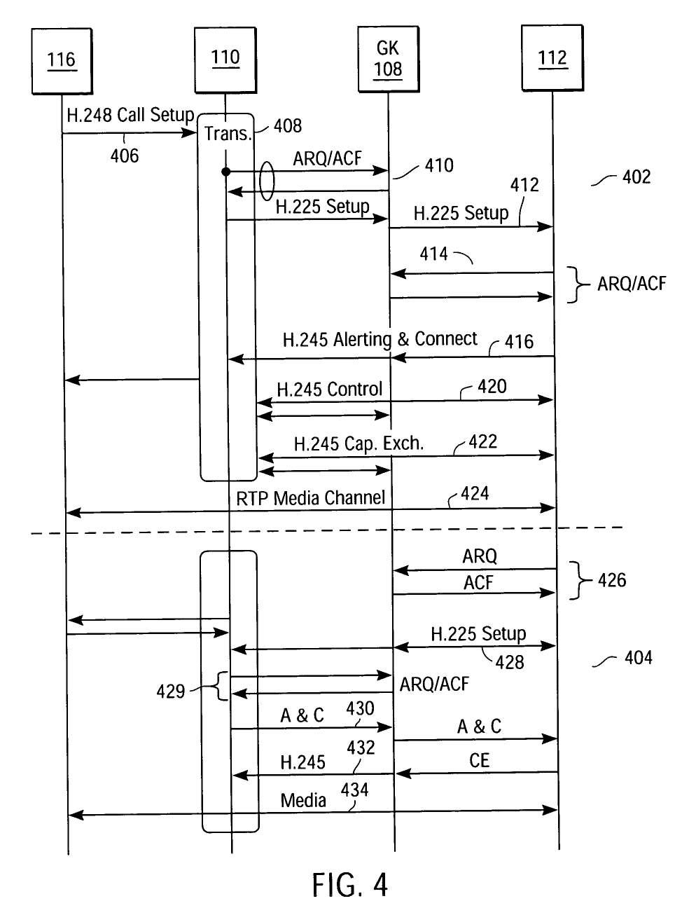

Turning now to FIG. 4, a signaling diagram illustrating operation of an embodiment of the present invention is shown. Shown are a non-H.323 endpoint 116, feature proxy 110, gatekeeper 108, and H.323 endpoint 112.

At 406, a user of a non-H.323 endpoint 116 begins a call by sending the appropriate call setup messaging to the feature proxy 110. At 408, the interworking unit 202 receives the incoming request signaling and performs one or more conversions to the H.323 protocol. At 410, the feature proxy 110 undertakes an H.225.0 ARQ/ACF exchange with the gatekeeper 108. At 412, the feature proxy 110 follows with an H.225.0 Setup message, which the gatekeeper 108 provides to the intended called party, the H.323 endpoint 112. In response, at 414, the endpoint 112 performs the ARQ/ACF exchange with the gatekeeper 108. At 416, the endpoint 112 sends H.225.0 Alerting and Connect messages to the gatekeeper 108, which provides them to the feature proxy 110, which is standing in for the endpoint 116. At 420, an H.245 control channel is opened and an H.245 capability exchange is made at 422. Finally, RTP media channels are opened at 424 between endpoints 112 and 116.

Call progress initiated by the endpoint 112 is shown at 404. At 426, the endpoint 112 sends and undertakes and ARQ/ACF exchange with the gatekeeper 108. At 428, once the ACF is received, the endpoint 112 sends an H.225.0 Setup message to the gatekeeper 108. The gatekeeper 108 then sends this to the feature proxy 110, which previously registered with the gatekeeper 110 on behalf of non-H.323 endpoint 116. At 429, the feature proxy 110 then performs an ARQ/ACF exchange with the gatekeeper 108, while accessing its database and conducting call setup procedures with the endpoint 116. At 430, the feature proxy 110 then sends H.225.0 Alerting and Connect messages to the gatekeeper 108, which provides them to the endpoint 112. At 432, the feature proxy 110 and the endpoint 112 perform an H.245 capabilities exchange, and the media channels between the endpoints 116 and 112 are set up at 434.

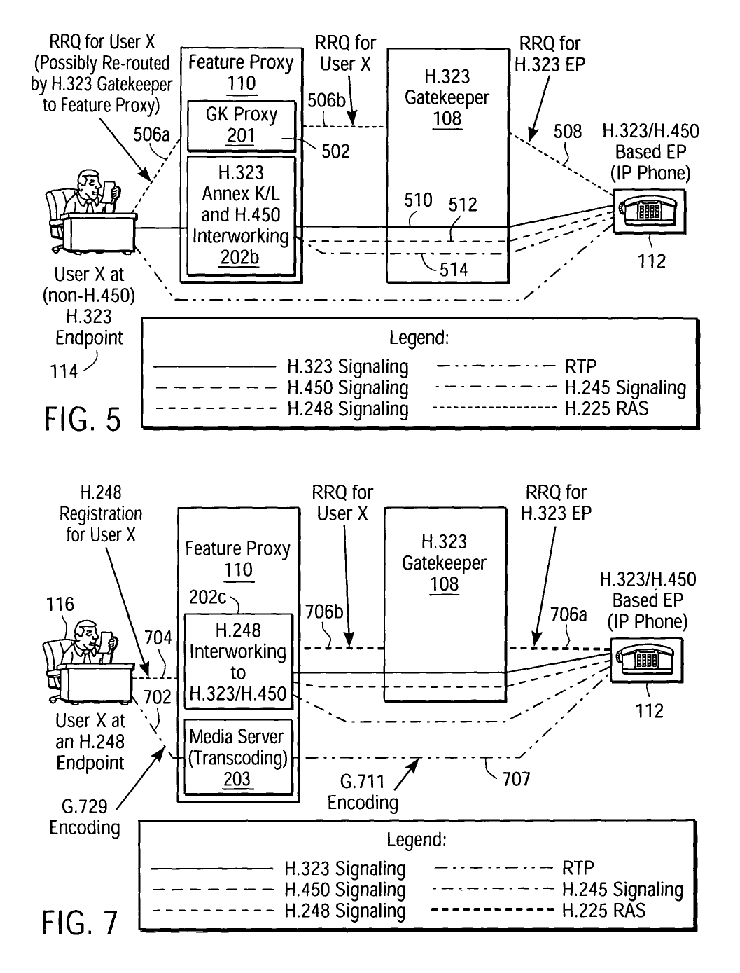

FIG. 5 illustrates registration for an endpoint having H.323 capabilities, but not H.450 capabilities. Shown in FIG. 5 are an H.323/H.450 compliant endpoint 112, an H.323 gatekeeper 108, the feature proxy 110, and an H.323, non-H.450 endpoint 114. As shown, the feature proxy 110 includes a gatekeeper proxy 201 and an Interworking Unit 202b. As shown, the non-H.450 endpoint 114 registers at the feature proxy 110 using an H.225.0 RRQ request 506a. This may be accomplished either by configuring the endpoint 114 with the feature proxy 110's address or by the gatekeeper 108 redirecting the RRQ to the feature proxy 110, using the H.323 alternate gatekeeper provision. In turn, the feature proxy 110 registers with the gatekeeper 108, at 506b. Once the feature proxy 110 has registered with the gatekeeper 108, all signaling is then handled via the feature proxy 110. In particular, the feature proxy 110 handles H.323 signaling and H.245 signaling on behalf of the endpoint 114.

The H.323 endpoint 112, in contrast, registers with gatekeeper 108, at 508. H.323 signaling 510, H.245 signaling 514, and H.450 signaling 512 is then passed through to the feature proxy 110 by the gatekeeper 108.

Turning now to FIG. 6, a signaling diagram illustrating operation of an embodiment of the present invention is shown. Shown are an H.323/non-H.450 endpoint 114, feature proxy 110, gatekeeper 108, and H.323/H.450 endpoint 112. Shown at 602 is the H.323/non-H.450 endpoint initiating a call. At 604, the endpoint 116 performs an ARQ/ACF exchange with the feature proxy 110 and, particularly, the gatekeeper proxy 201. In turn, at 606, the gatekeeper proxy 201 performs an ARQ/ACF exchange with the gatekeeper 108. At 608, the client 114 sends an H.225.0 Setup message to the gatekeeper proxy 201, which sends it to the gatekeeper 108 which sends it on to the endpoint 112. In response, at 610, the endpoint 112 performs an ARQ/ACF exchange with the gatekeeper 108, which is relayed to the gatekeeper proxy at 612. At 614, the endpoint 112 sends H.225.0 Alerting and Connect messages to the endpoint 114 via the gatekeeper 108 and feature proxy 110. At 616, an H.245 capabilities exchange is performed and at 618, media channels are opened between endpoints 112 and 114. If the endpoint 112 then wishes to make use of an H.450 supplementary service 619, the request is handled via the gatekeeper proxy 201.

The endpoint 112 initiating a call is shown at 604. At 622, the ARQ/ACF exchange is performed between the gatekeeper 108 and the endpoint 112. At 624, the gatekeeper 108 forwards this exchange to the gatekeeper proxy 201. In response to the ACF message, the endpoint 112 sends an H.225.0 Setup message to the gatekeeper 108 which, again, is forwarded to the gatekeeper proxy 201. Thus, in a step 626, the gatekeeper 108 relays the H.225.0 Setup message to the endpoint 114 via the feature proxy 110. In response, in a step 628, the endpoint 114 conducts an ARQ/ACF exchange with the gatekeeper 108 via the gatekeeper proxy 201. In a step 630, the endpoint 114 sends H.225.0 Alerting and Connect messages to the gatekeeper proxy 201 and the gatekeeper 108 as the call progresses to the connect state. Also in step 630, the gatekeeper 108, in turn provides the Alerting and Connect messages to the endpoint 112. Next, an H.245 capability exchange is undertaken in a step 634 between endpoints 112 and 114. In a step 636 the media channels are opened between endpoints 112 and 114. If the endpoint 112 then wishes to make use of an H.450 supplementary service, the request is handled via the gatekeeper proxy 201.

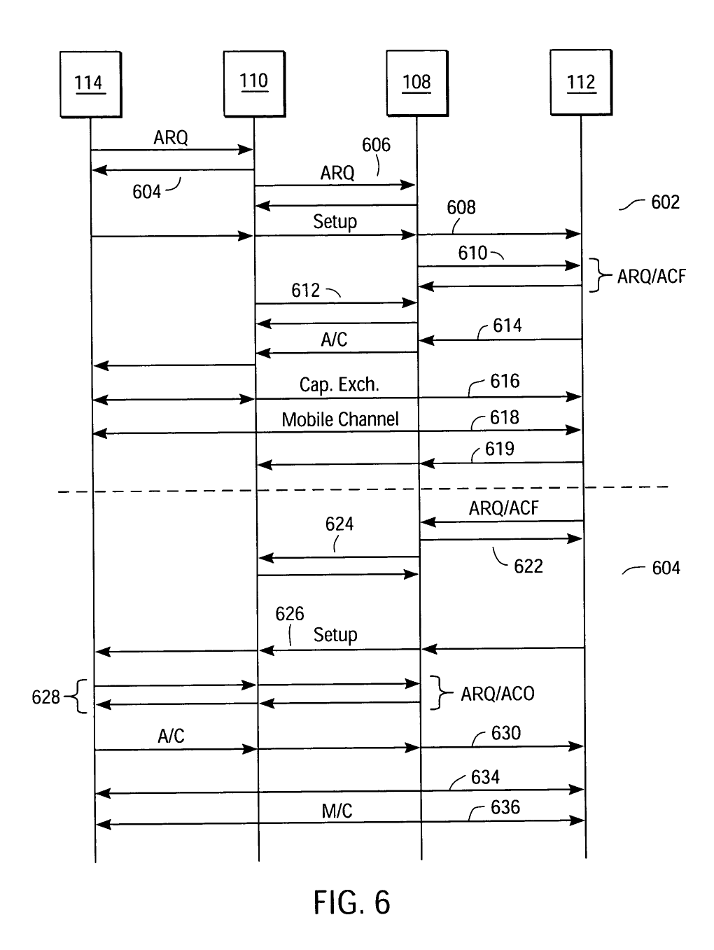

Turning now to FIG. 7, a diagram illustrating an example of a user registering from an endpoint 116 that is not an H.323 endpoint and which requires codec transcoding. For example, the endpoint might be an H.248 endpoint employing G.729 encoding, although handling for other non-H.323 endpoints is similar. Shown in FIG. 7 are an H.323/H.450 compliant endpoint 112, an H.323 gatekeeper 108, the feature proxy 110, and a non-H.323 endpoint 116. As in the example of FIG. 3, the feature proxy 110 includes an interworking control unit 202 and, in particular, an H.248 interworking with H.323/H.450 interworking unit. In addition, in the embodiment illustrated, the feature proxy 110 includes a transcoding unit 203 for converting between the G.729 encoding and the encoding employed by the endpoint 112, such as G.711 encoding.

At 704, the non-H.323 endpoint 116 registers with the feature proxy 110 using its native protocol (i.e., H.248 in this example). At 706a the H.323 endpoint 112 sends an H.225.0 RRQ (Registration Request) message to the H.323 gatekeeper 108. The RRQ request is then sent to the feature proxy 110. This may be accomplished either by configuring the endpoint 112 with the feature proxy 110's address or by the gatekeeper 108 redirecting the RRQ to the feature proxy 110, using the H.323 alternate gatekeeper provision. The feature proxy 110 receives the RRQ and sends its own RRQ request 706b on behalf of the H.323 endpoint 112 to the gatekeeper 108. This indicates the feature proxy 110 as the address of the terminal 112. Thus, all signaling and call information for the terminal 112 is routed to the feature proxy 110. Similarly, the feature proxy 110 sends an RRQ to the gatekeeper 108 for the H.248 endpoint 116. The feature proxy 110 can then process and relay H.225.0 RAS and H.225.0 signaling messages, H.245 control messages, H.450 messages, and cryptographic tokens for support of H.235 security procedures between the endpoints and the H.323 gatekeeper. RTP signaling is handled directly between the endpoints 116 and 112. Finally, as will be explained in greater detail below, at 702, the endpoint 116 communicates via the transcoding unit 203 at the feature proxy 110 using G.729 encoding. The transcoding unit 203 then converts the received stream to G.711 encoding at 707.

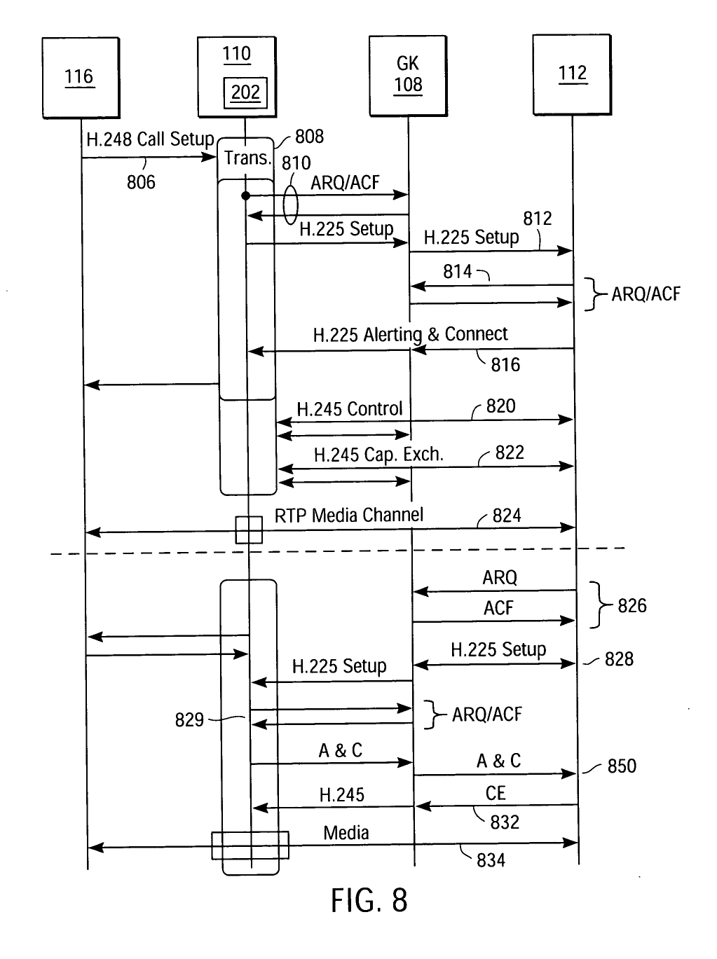

Turning now to FIG. 8, a signaling diagram illustrating operation of an embodiment of the present invention is shown. Shown are a non-H.323 endpoint 116, feature proxy 110, gatekeeper 108, and H.323 endpoint 112.

At 806, a user of a non-H.323 endpoint 116 begins a call by sending the appropriate call setup messaging to the feature proxy 110. At 808, the interworking unit 202 of feature proxy 110 receives the incoming request signaling and performs one or more conversions to the H.323 protocol. At 810, the feature proxy 110 undertakes an H.225.0 ARQ/ACF exchange with the gatekeeper 108. At 812, the feature proxy 110 follows with an H.225.0 Setup message, which the gatekeeper 108 provides to the intended called party, the H.323 endpoint 112. In response, at 814, the endpoint 112 performs the ARQ/ACF exchange with the gatekeeper 108. At 816, the endpoint 112 sends H.225.0 Alerting and Connect messages to the gatekeeper 108, which provides them to the feature proxy 110, which is standing in for the endpoint 116. At 820, an H.245 control channel is opened and an H.245 capability exchange is made at 822. During the H.245 capability exchange with terminal 112, the capabilities of the transcoding unit 203 are substituted for the media capabilities of terminal 116. Finally, RTP media channels are opened at 824 between endpoints 112 and 116.

Call progress initiated by the endpoint 112 is shown at 804. At 826, the endpoint 112 sends and undertakes and ARQ/ACF exchange with the gatekeeper 108. At 828, once the ACF is received, the endpoint 112 sends an H.225.0 Setup message to the gatekeeper 108. The gatekeeper 108 then sends this to the feature proxy 110, which previously registered with the gatekeeper 110 on behalf of non-H.323 endpoint 116. At 829, the feature proxy then performs an ARQ/ACF exchange with the gatekeeper, while accessing its database and conducting call setup procedures with the endpoint 116. At 830, the feature proxy 110 then sends H.225.0 Alerting and Connect messages to the gatekeeper 108, which provides them to the endpoint 112. At 832, the feature proxy 110 and the endpoint 112 perform an H.245 capabilities exchange, and the media channels between the endpoints 116 and 112 are set up at 834. During the H.245 capability exchange with terminal 112, the capabilities of the transcoding unit 203 are substituted for the media capabilities of terminal 116.

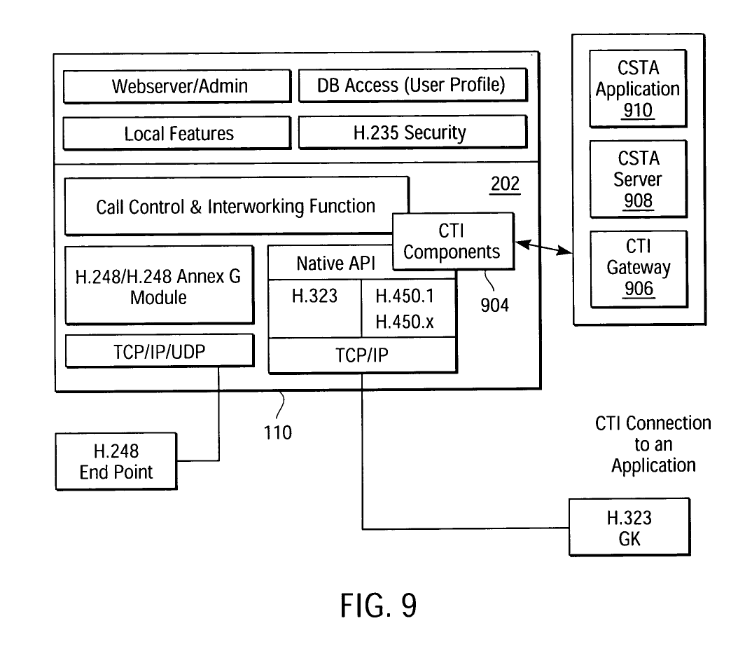

In addition to functioning as a proxy, the feature proxy of the present invention can be used to implement CTI (computer-telephony integration) monitoring and control of the endpoints for which it provides features. For example a dialer program could be run on a personal computer (PC) that would provide a visual display of the current call state of a network client including the calling party. This application could also allow the user to place calls on the network client using addresses stored on the PC. Other applications could be provided that would generate a computerized log of all calls made by a network client. As shown in FIG. 9, in the embodiment illustrated, the feature server 110 includes the interworking unit 202 (with H.248 stack and H.323 stack, as well as a call control interworking controller). In addition, the feature proxy 110 includes a CTI interface 904. The CTI interface 904 couples to a CSTA (computer supported telephony applications) application 910. The CSTA application may be implemented as a program running on a personal computer coupled to the network 101.

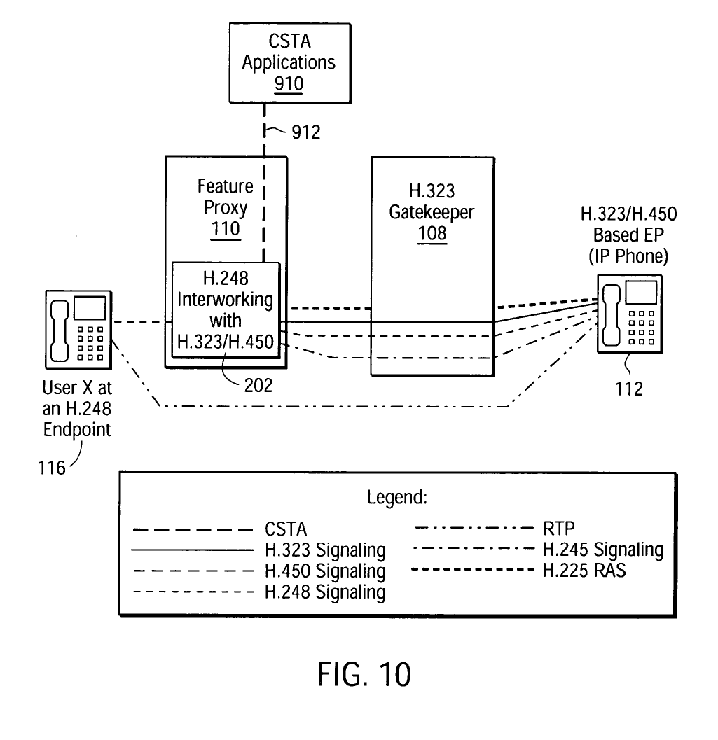

FIG. 10 illustrates an example of a CSTA application 910 controlling a user registering from an endpoint 116 that is not an H.323 endpoint. Similar to FIG. 3, shown in FIG. 10 are an H.323/H.450 compliant endpoint 112, an H.323 gatekeeper 108, the feature proxy 110, and a non-H.323 endpoint 116. The feature proxy 110 includes an interworking control unit 202 and, in particular, an H.248 interworking with H.323/H.450 interworking unit. In operation, the feature proxy 110 sends and receives control signals from the CSTA application 912. In receiving, the proxy may translate the control signals into commands for network devices in their native protocols. Similarly, the proxy may receive signals from the network devices and translate them into signals usable by the CSTA application.

The invention described in the above detailed description is not intended to be limited to the specific form set forth herein, but is intended to cover such alternatives, modifications and equivalents as can reasonably be included within the spirit and scope of the appended claims.

1. A telecommunications system, comprising:
a packet network;
a first plurality of network clients compatible with a first voice protocol of said network;
a second plurality of network clients partially compatible with said first voice protocol;
a third plurality of network clients compatible with a second voice protocol;
a gatekeeper adapted to provide call control for said first plurality of network clients;
a feature proxy adapted to receive registrations of said first plurality, said second plurality, and said third plurality of endpoints that maps such registrations to registrations with said gatekeeper and provides feature processing for said first, second, and third plurality of endpoints.

2. A telecommunications system in accordance with claim 1, wherein said feature processing comprises supplementary service feature processing.

3. A telecommunications system in accordance with claim 1, wherein said feature processing comprises media stream feature processing.

4. A telecommunications system in accordance with claim 1, wherein said feature proxy is further adapted to implement CTI control of said endpoints.

5. A telecommunications system in accordance with claim 1, wherein each of said first plurality of network clients is mapped to a corresponding registration with said gatekeeper.

6. A telecommunications system in accordance with claim 5, wherein each of said third plurality of network clients is mapped to a single registration with said gatekeeper.

7. A telecommunications method for use in a telephony-over-LAN network, comprising:
receiving first registrations of a first plurality of network clients at a feature proxy;
receiving second registrations of a second plurality of network clients at said feature proxy;
mapping said first registrations to corresponding registrations with a network gatekeeper; and
mapping said second registrations to a single corresponding registration with said network gatekeeper.

8. A telecommunications method in accordance with claim 7, wherein said first plurality of network clients are compatible with a voice protocol of said LAN.

9. A telecommunications method in accordance with claim 8, wherein said second plurality of network clients are compatible with a different voice protocol.

10. A telecommunications method in accordance with claim 9, further comprising said feature proxy interworking said first plurality and said second plurality.
